(19) United States
(12) Patent Application Publication
(10) Pub. No.: US 2026/0309999 A1
(43) Pub. Date: Oct. 8, 2026

(54) FIELD OF VIEW AREA SELECTION USING ELECTROCHROMIC FACETS

(71) Applicant: GOOGLE LLC, Mountain View, CA (US)

(72) Inventors: Daniel Adema, Kitchener (CA); Shreyas Potnis, Kitchener (CA)

(21) Appl. No.: 18/996,626

(22) PCT Filed: Jul. 17, 2023
(86) PCT No.: PCT/US2023/027920

§ 371 Date: Jan. 17, 2025

Related U.S. Application Data
(60) Provisional application No. 63/390,115, filed on Jul. 18, 2022.

(51) Int. Cl. G02B 27/01; G02B 27/00; G02F 1/157

(52) U.S. Cl. CPC G02B 27/0179; G02B 27/0093; G02B 27/0172; G02F 1/157; G02B 2027/0123; G02B 2027/0138; G02B 2027/014; G02B 2027/0178; G02B 2027/0187

(57) ABSTRACT

To increase the field of view (FOV) area in a head-worn display (HWD), the HWD includes an optical engine (202) configured to emit a display light representing one or more images toward a lightguide (205) of the HWD. Further, the HWD includes an electrochromic reflector having one or more electrochromic facets (322). These electrochromic facets are configured to direct the display light such that the display light propagates through the lightguide along a path of a plurality of paths based on one or more respective states of electrochromic facets. By increasing the number of paths at which the display light propagates through the lightguide, the FOV area is increased.

### BACKGROUND

In some head-wearable displays (HWD), images are displayed to a user by coupling light beams from a projector into an incoupler of a lightguide. The incoupler then provides the light beams to a main body of the lightguide within which the light beams propagate by total internal reflection (TIR). The light beams propagate through the lightguide until they are received at an outcoupler of the lightguide configured to direct the light beams out of the lightguide and toward the user such that images are presented to the user in a field of view (FOV) area of the HWD. To increase the FOV area for the user, some HWDs use projectors that provide additional light beams at a greater number of angles to the incoupler of the lightguide. However, to provide these additional light beams, the size and power demands of a projector are increased, which increases the overall size of the HWD and negatively impacts user experience.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a diagram of an example display system housing a projector system configured to project images toward the eye of a user, in accordance with some embodiments.

FIG. 2 is a diagram of a projection system that projects images directly onto the eye of a user via display light, in accordance with some embodiments.

FIG. 3 is a diagram of a projection system including an electrochromic reflector disposed within a lightguide in accordance with some embodiments.

FIG. 4 is a diagram of a projection system including an electrochromic reflector with two or more electrochromic facets, in accordance with some embodiments.

FIG. 5 is a diagram of a stacked lightguide including an electrochromic reflector, in accordance with some embodiments.

FIG. 6. is a diagram of a split exit pupil expander including an electrochromic reflector, in accordance with some embodiments.

FIG. 7 presents example overlapping portions of a field of view area provided by an electrochromic reflector, in accordance with some embodiments.

FIG. 8 presents example separated portions of a field of view area provided by an electrochromic reflector, in accordance with some embodiments.

FIG. 9 is a diagram illustrating a partially transparent view of a head-worn display that includes a projection system, in accordance with some embodiments.

### SUMMARY OF EMBODIMENTS

Techniques and systems described herein are directed to increasing the field of view (FOV) area in a head-worn display (HWD) using an electrochromic reflector. According to an example embodiment, an HWD includes an optical engine configured to emit display light. Further, the HWD can include a lightguide and an electrochromic facet. The electrochromic facet can be configured to direct the display light such that the display light propagates through the lightguide along a path of a plurality of paths based on a state of the electrochromic facet.

In embodiments, each path of the plurality of paths may correspond to a respective portion of a field of view (FOV) area of the HWD. Further, the electrochromic facet may be configured to direct the display light such that the display light propagates through the lightguide along a first path of the plurality of paths based on the electrochromic facet being in a first state. Also, the display light propagating through the lightguide along the first path of the plurality of paths can be configured to illuminate a first portion of the FOV area. As well, the first state can include a reflective state and the electrochromic facet can be configured to reflect the display light such that the display light propagates through the lightguide along the first path of the plurality of paths.

According to embodiments, the electrochromic facet can be configured to direct the display light such that the display light propagates through the lightguide along a second path of the plurality of paths based on the electrochromic facet being in a second state. Additionally, the display light propagating through the lightguide along the second path of the plurality of paths may be configured to illuminate a second portion of the FOV area. Further, the second state may include a transmittance state and the electrochromic facet can be configured to transmit the display light to a reflective facet. Also, the reflective facet can be configured to reflect the display light such that the display light propagates through the lightguide along the second path of the plurality of paths. Within the HWD, the electrochromic facet can be disposed at a first angle relative to a surface of the lightguide and the reflective facet can be disposed at a second angle relative to the surface of the lightguide. The first angle may be different from the second angle. Further, the HWD can include a mirror control circuitry configured to control the state of the electrochromic facet based on a gaze of a user. Also, the electrochromic facet can be disposed within the lightguide.

In another example embodiment, a lightguide for an HWD includes one or more electrochromic facets configured to direct a display light such that the display light propagates through the lightguide along a path of a plurality of paths based on one or more respective states of the one or more electrochromic facets.

In embodiments, each path of the plurality of paths may correspond to a respective portion of an FOV area of the HWD. Further, a first facet of the one or more electrochromic facets may be configured to direct the display light such that the display light propagates through the lightguide along a first path of the plurality of paths based on a first electrochromic facet being in a first state. The first state can include a reflective state and the first electrochromic facet may be configured to reflect the display light such that the display light propagates through the lightguide along the first path. Additionally, the first electrochromic facet can be configured to transmit the display light to a second electrochromic facet of the one or more electrochromic facets based on the first electrochromic facet being in a second state. Further, the second electrochromic facet can be configured to direct the display light such that the display light propagates through the lightguide along a second path of the plurality of paths based on the second electrochromic facet being in the first state.

As well, the second electrochromic facet can be configured to direct the display light such that the display light propagates through the lightguide along a third path of the plurality of paths based on the second electrochromic facet being in the second state. Additionally, the one or more respective states of the one or more electrochromic facets may be determined by a mirror control circuitry configured to control the one or more respective states of the one or more electrochromic facets based on a gaze of a user. The one or more electrochromic facets can be disposed within the lightguide.

In another example embodiment, a method includes emitting a display light toward a lightguide. The method can additionally include directing, by an electrochromic facet disposed within the lightguide, the display light such that the display light propagates through the lightguide along a path of a plurality of paths based on a state of the electrochromic facet.

According to embodiments, within the method, each path of the plurality of paths can correspond to a respective portion of an FOV area. Additionally, the method can include directing, by the electrochromic facet, the display light such that the display light propagates through the lightguide along a first path of the plurality of paths based on the electrochromic facet being in a first state. The display light propagating through the lightguide along the first path of the plurality of paths may be configured to illuminate a first portion of the FOV area.

In embodiments, the method further includes directing, by the electrochromic facet, the display light such that the display light propagates through the lightguide along a second path of the plurality of paths based on the electrochromic facet being in a second state. The display light propagating through the lightguide along the second path of the plurality of paths can be configured to illuminate a second portion of the FOV area. As well, the method can include controlling the state of the electrochromic facet based on a gaze of a user.

### DETAILED DESCRIPTION

Some head-worn displays (HWDs) (e.g., extended reality head-worn displays) are designed to look like eyeglasses, with at least one of the eyeglass lenses containing a lightguide to direct light to a user's eye. The combination of the lens and lightguide is referred to as an “optical combiner,” “optical combiner lens,” or both. Such lightguides include, for example, exit pupil expanders (EPEs) and outcouplers that form and guide light to the user's eye such that images are presented to a user within a field of view (FOV) area of the optical combiner. The HWDs generally have a frame designed to be worn in front of a user's eyes to allow the user to view both their environment and the computer-generated content displayed in the FOV area of the optical combiner. Components that are necessary to the functioning of a typical HWDs, such as, for example, an optical engine to project computer-generated content (e.g., display light representative of one or more images), cameras to pinpoint physical location, cameras to track the gaze of the user's eye(s), processors to power the optical engine, and a power supply, are typically housed within the frame of the HWD. As an HWD frame has limited volume in which to accommodate these components, it is desirable that these components be as small as possible and configured to interact with the other components in very small volumes of space.

To guide light to a user's eye, the optical engine of the HWD is configured to emit display light representing an image toward an incoupler of the lightguide. Such an incoupler, for example, includes one or more reflective facets (e.g., structures configured to reflect light) that provide the received light to a main body of the lightguide. The light then propagates through the lightguide using total internal reflection (TIR), partial internal reflection (PIR), or both until the light is received at an outcoupler of the lightguide. The outcoupler, for example, includes one or more reflective facets (e.g., structures configured to reflect light) that direct the light out of the lightguide and toward the eye of the user such that one or more images are presented to the user within the FOV area of an optical combiner. To increase the FOV area of the optical combiner in which images are displayed, some HWDs include optical engines configured to provide display light at a greater number of angles to a lightguide so as to increase the FOV area. However, providing display light at a greater number of angles to a lightguide requires substantially increasing the size of the optical engine, which, in turn, increases the size of the HWD and negatively impacts user experience. Additionally, the optical engine must consume more power in order to illuminate the increased FOV area. Further, to increase the FOV area, some HWDs include one or more scan mirrors configured to divert the display light provided from the optical engine so as to illuminate different portions of an increased FOV area at different times. For example, a scan mirror is configured to, at a first time, divert light from the optical engine in a first direction such that a first portion of the increased FOV area is illuminated and, at a second time, divert light from the optical engine such that a second portion of the increased FOV area is illuminated. However, including such a scan mirror within the HWD also substantially increases the size of the HWD and negatively impacts user experience.

To this end, systems and techniques disclosed herein are directed to increasing the FOV area of an HWD without substantially increasing the size of the HWD. For example, to increase the size of the FOV area of the HWD, the HWD includes a lightguide that has an electrochromic reflector disposed within the lightguide. This electrochromic reflector, for example, includes one or more electrochromic facets, one or more reflective facets, or both. These electrochromic facets include structures configured to reflect light while in a reflective state and transmit light while in a transmission state. To control the states of the electrochromic facets, the HWD includes a mirror control circuitry configured to provide control signals that set the state (reflective or transmissive) of each electrochromic facet of the electrochromic reflector. Based on the state of one or more electrochromic facets, the electrochromic reflector is configured to divert display light received at the lightguide so as to illuminate respective portions of the FOV area. For example, based on an electrochromic facet of the electrochromic reflector being in a reflective state, the electrochromic facet is configured to reflect divert display light received at the lightguide such that the display light propagates through the lightguide using a first path and illuminates a first portion of the FOV area. Further, based on an electrochromic facet of the electrochromic reflector being in a transmission state, the electrochromic facet is configured to transmit the display light to a reflective facet which reflects the display light such that the display light propagates through the lightguide using a second path and illuminates a second portion of the FOV area. In this way, the electrochromic reflector increases the size of the FOV area by increasing the number of paths in which the display light propagates through the lightguide without increasing the power demands of the optical engine due to only portions of the increased FOV area being illuminated at a time. Further, because the electrochromic reflector is disposed within the lightguide, the size of the FOV area is increased without increasing the size of the HWD, improving user experience.

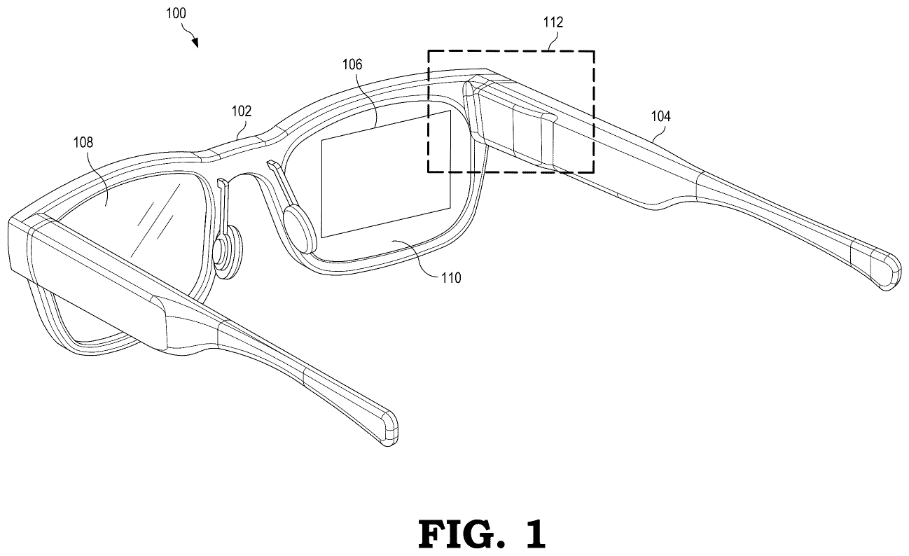

FIG. 1 illustrates an example display system 100 having a support structure 102 that includes an arm 104, which houses a projection system configured to project images toward the eye of a user, such that the user perceives the projected images as being displayed in an FOV area 106 of a display at one or both of lens elements 108, 110. In the depicted embodiment, the display system 100 is an HWD that includes a support structure 102 configured to be worn on the head of a user and has a general shape and appearance of an eyeglasses frame or sunglasses frame. The support structure 102 contains or otherwise includes various components to facilitate the projection of such images toward the eye of the user, such as a projector (e.g., optical engine) and a lightguide. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth interface, a Wi-Fi interface, and the like. Further, in some embodiments, the support structure 102 further includes one or more batteries or other portable power sources for supplying power to the electrical components of the display system 100. In some embodiments, some or all of these components of the display system 100 are fully or partially contained within an inner volume of support structure 102, such as within the arm 104 in region 112 of the support structure 102. It should be noted that while an example form factor is depicted, it will be appreciated that in other embodiments the display system 100 may have a different shape and appearance from the eyeglasses frame depicted in FIG. 1.

One or both of the lens elements 108, 110 are used by the display system 100 to provide an extended reality (XR) display in which rendered graphical content can be superimposed over or otherwise provided in conjunction with a real-world view as perceived by the user through the lens elements 108, 110. For example, display light used to form a perceptible image or series of images may be projected (e.g., emitted) by a projector of the display system 100 onto the eye of the user via a series of optical elements, such as a lightguide formed at least partially in the corresponding lens element. One or both of the lens elements 108, 110 thus include at least a portion of a lightguide that routes display light received by an incoupler of the lightguide to an outcoupler of the lightguide, which outputs the display light toward an eye of a user of the display system 100. The display light is modulated onto the eye of the user such that the user perceives the display light as an image. In addition, each of the lens elements 108, 110 is sufficiently transparent to allow a user to see through the lens elements to provide an FOV area 106 of the user's real-world environment such that the image appears superimposed over at least a portion of the real-world environment. In embodiments, to help expand the FOV area 106, the display system 100 includes an electrochromic reflector configured to provide light into the lightguide such that the FOV area 106 is expanded. For example, the electrochromic reflector is configured to reflect light along different paths within the lightguide so as to increase the FOV area 106. According to embodiments, this electrochromic reflector is configured to reflect light the light propagates through the lightguide along a path determined by the state of one or more electrochromic facets within the electrochromic reflector, liquid crystal displays (LCDs) within the electrochromic reflector, or both.

In some embodiments, the projector is a digital light processing-based projector, a micro-projector, a scanning laser projector, or any combination of a modulative light source such as a laser or one or more LEDs and a dynamic reflector mechanism such as one or more dynamic scanners or digital light processors. In some embodiments, the projector includes multiple laser diodes (e.g., a red laser diode, a green laser diode, and/or a blue laser diode). The projector is communicatively coupled to the controller and a non-transitory processor-readable storage medium or a memory that stores processor-executable instructions and other data that, when executed by the controller, cause the controller to control the operation of the projector.

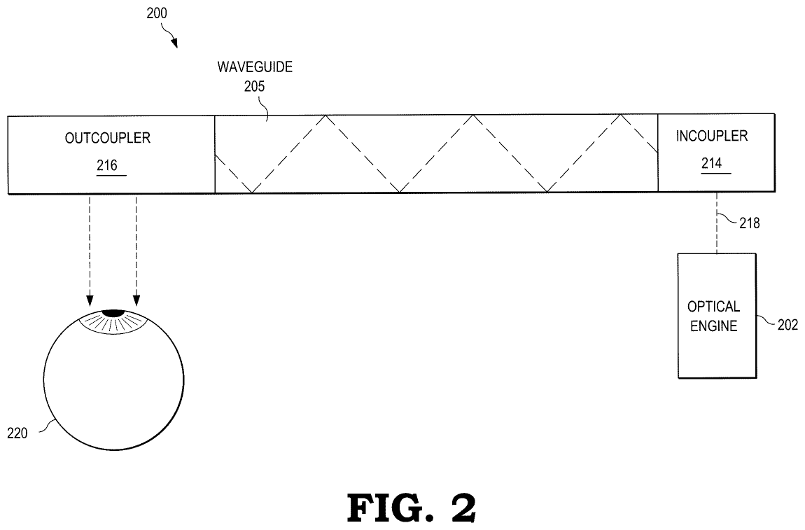

FIG. 2 illustrates a simplified block diagram of a projection system 200 that projects images directly onto the eye of a user via display light. The projection system 200 includes an optical engine 202 and a lightguide 205. The term “lightguide,” as used herein, will be understood to mean a combiner using one or more of total internal reflection (TIR), partial internal reflection (PIR), specialized filters, and/or reflective surfaces, to transfer light from an incoupler (such as the incoupler 214) to an outcoupler (such as the outcoupler 216). In some display applications, the light is a collimated image, and the lightguide transfers and replicates the collimated image to the eye. In some embodiments, the projection system 200 is implemented in a WHD or other display system, such as the display system 100 of FIG. 1.

The optical engine 202 includes one or more display light sources configured to generate and output display light 218 (e.g., visible display light such as red, blue, and green display light and/or non-visible display light such as infrared display light) representing an image. In some embodiments, the optical engine 202 is coupled to a driver or other controller (not shown), which controls the timing of emission of display light from the display light sources of the optical engine 202 in accordance with instructions received by the controller or driver from a computer processor coupled thereto to modulate the display light 218 to be perceived as images when output to the retina of an eye 220 of a user. For example, during the operation of the projection system 200, multiple display light beams having respectively different wavelengths are output by the display light sources of the optical engine 202, then combined via a beam combiner (not shown), before being directed to the eye 220 of the user. The optical engine 202 modulates the respective intensities of the display light beams so that the combined display light reflects a series of pixels of an image, with the particular intensity of each display light beam at any given point in time contributing to the amount of corresponding color content and brightness in the pixel being represented by the combined display light at that time.

Further, the lightguide 205 includes an incoupler 214 and an outcoupler 216, with the outcoupler 216 being optically aligned with an eye 220 of a user in the present example. In some embodiments, the incoupler 214 has a substantially rectangular, circular, or elliptical profile and is configured to receive the display light 218 and direct the display light 218 into the lightguide 205. To this end, the incoupler 214 includes one or more reflective facets configured to reflect and direct display light 218 into the lightguide 205. Such reflective facets, for example, include one or more structures disposed within the lightguide 205 that each has one or more reflective surfaces, reflective coatings, mirrors (e.g., di-electric mirrors, metallic mirrors, Bragg facets), mirror coatings, or any combination thereof. According to embodiments, in response to receiving display light 218, the incoupler 214 is configured to provide the display light 218 to lightguide 205 such that the display light 218 propagates through lightguide 205 via TIR until it is received by the outcoupler 216. As an example, the incoupler 214 provides display light 218 to lightguide 205 such that display light 218 performs one or more bounces (e.g., reflects off a surface of lightguide 205) before being received by the outcoupler 216. After receiving display light 218, the outcoupler 216 is configured to direct display light 218 out of the lightguide 205 and toward the eye 220 of the user. For example, the outcoupler 216 includes one or more reflective facets configured to reflect and direct display light 218 out of the lightguide 205 and toward the eye 220 of a user such that one or more images are displayed in the FOV area 106. Such reflective facets, for example, include one or more structures disposed within the lightguide 205 that each has one or more reflective surfaces, reflective coatings, mirrors (e.g., di-electric mirrors, metallic mirrors, Bragg facets), mirror coatings, or any combination thereof. In an embodiment, the display light 218 directed out of the lightguide 205 by the outcoupler 216 forms an exit pupil at a position near the eye 220 of the user. An exit pupil, for example, includes the image of the display light 218 emitted by optical engine 202 and refers to the location along the optical path where two or more beams of the display light 218 intersect. As an example, the width (e.g., smallest dimension) of a given exit pupil approximately corresponds to the diameter of the display light 218 corresponding to that exit pupil. Accordingly, the exit pupil can be considered a “virtual aperture”.

Although not shown in the example of FIG. 2, in some embodiments additional optical components are included in any of the optical paths between the optical engine 202 and the incoupler 214, between the incoupler 214 and the outcoupler 216, and/or between the outcoupler 216 and the eye 220 (e.g., in order to shape the display light for viewing by the eye 220 of the user). In some embodiments, an electrochromic reflector is used to steer light into the incoupler 214 so that light is coupled into incoupler 214 at the appropriate angle to encourage the propagation of the light in lightguide 205 by TIR. Also, in some embodiments, an exit pupil expander (EPE), such as a fold grating, is arranged in an intermediate stage between incoupler 214 and outcoupler 216 to receive light that is coupled into lightguide 205 by the incoupler 214, expand the light, and redirect the light towards the outcoupler 216, where the outcoupler 216 then couples the display light out of lightguide 205 (e.g., toward the eye 220 of the user).

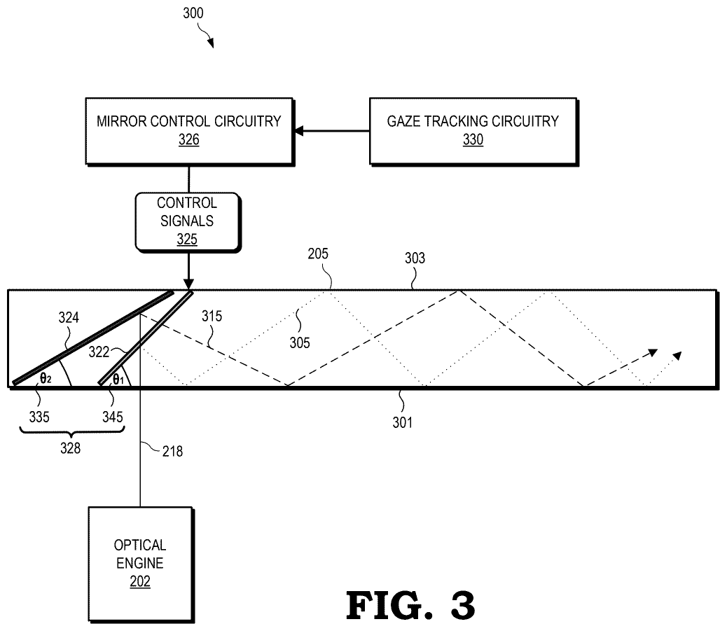

Referring now to FIG. 3, a projection system 300 including an electrochromic reflector disposed within a lightguide is presented. According to embodiments, projection system 300 is similar to or the same as projection system 200 and, in some embodiments, is implemented in an HWD or other display system, such as the display system 100 of FIG. 1. Within projection system 300, lightguide 205 has a first surface 301 (e.g., user-facing surface) and a second surface 303 (e.g., world-facing surface) opposite the first surface 301. Further, lightguide 205 includes an electrochromic reflector 328 disposed within lightguide 205 that includes one or more electrochromic facets 322. An electrochromic facet 322 includes a structure configured to reflect received light while in a first state (e.g., reflective state) and transmit light while in a second state (e.g., transmittance state). As an example, an electrochromic facet 322 includes one or more electrochromic layers each disposed on a structure (e.g., facet) of a lightguide and configured to reflect light when a first current is applied to the electrochromic layer and transmit light when a second current is applied to the electrochromic layer that is different from the first current. As another example, an electrochromic facet 322 includes an LCD that is configured to reflect light when a first current is applied to the LCD and transmit light when a second current is applied to the LCD that is different from the first current. Though the example embodiment presented in FIG. 3 shows the electrochromic reflector 328 as including one electrochromic facet 322, in other embodiments, the electrochromic reflector 328 can include any number of electrochromic facets 322. Additionally, in some embodiments, the electrochromic reflector 328 includes one or more reflective facets 324. A reflective facet 324, for example, includes one or more structures configured to reflect received light, for example, one or more reflective surfaces, reflective coatings, mirrors (e.g., di-electric mirrors, metallic mirrors, Bragg facets), mirror coatings, or any combination thereof. Though the example embodiment presented in FIG. 3 shows the electrochromic reflector 328 as including one reflective facet 324, in other embodiments, the electrochromic reflector 328 can include any number of reflective facets 324.

To control the state of one or more electrochromic facets 322 of electrochromic reflector 328, projection system 300 includes mirror control circuitry 326. Mirror control circuitry 326 is configured to provide one or more control signals 325 to one or more electrochromic facets 322 of electrochromic reflector 328 and is configured to change the state of an electrochromic facet 322 by changing one or more of the control signals 325 provided to the electrochromic facet 322. That is to say, mirror control circuitry 326 is configured to control the state of one or more electrochromic facets 322 by providing one or more control signals 325 to the electrochromic facets 322. Such control signals 325, for example, represent a voltage, current, or both provided to an electrochromic facet 322. As an example, in response to mirror control circuitry 326 providing a control signal 325 representing a first current to an electrochromic facet 322, the electrochromic facet 322 is configured to enter a first state (e.g., reflective state). Further, in response to mirror control circuitry 326 providing a control signal 325 representing a second current different from the first current, the electrochromic facet 322 is configured to enter a second state (e.g., transmittance state).

In embodiments, projection system 300 includes optical engine 202 emitting display light 218 representing one or more images toward a first surface 301 of lightguide 205. After passing through the first surface 301 of lightguide 205, display light 218 is received by electrochromic reflector 328 disposed within lightguide 205. According to embodiments, the electrochromic reflector 328 is configured to direct display light 218 such that display light 218 propagates, via TIR, within lightguide 205 based on the state of one or more electrochromic facets 322 of the electrochromic reflector 328. As an example, when the electrochromic facet 322 of the electrochromic reflector 328 is in a first state (e.g., reflective state), electrochromic reflector 328 is configured to direct display light 218 such that display light 218 propagates through lightguide 205 along a first path 305. Regarding the example embodiment presented in FIG. 3, for example, display light 218 is received by electrochromic facet 322 after display light 218 passes through the first surface 301 of lightguide 205. In embodiments, electrochromic facet 322 is disposed within lightguide 205 such that electrochromic face 322 has an angle θ₁ 345 relative to the surface 301 of lightguide 205. Due to electrochromic facet 322 being in a first state (e.g., reflective state), electrochromic facet 322 is configured to reflect display light 218 based on the angle θ₁ 345 of electrochromic facet 322. For example, electrochromic facet 322 is configured to reflect display light 218 such that display light 218 propagates through lightguide 205 along a first path 305. According to embodiments, the first path 305 is associated with a first portion of an FOV area 106 to be illuminated. That is to say, display light 218 propagating through lightguide 205 along the first path 305 is configured to illuminate a first portion of FOV area 106.

As another example, based on an electrochromic facet 322 of the electrochromic reflector 328 being in a second state (e.g., transmittance state), electrochromic reflector 328 is configured to direct received light (e.g., display light 218) such that the received light propagates through lightguide 205 along a second path. Regarding the example embodiment presented in FIG. 3, for example, display light 218 is received by electrochromic facet 322 after display light 218 passes through the first surface 301 of lightguide 205. Due to electrochromic facet 322 being in a second state (e.g., transmittance state), electrochromic facet 322 is configured to transmit display light 218 toward the reflective facet 324. According to embodiments, the reflective facet 324 is disposed within lightguide 205 such that the reflective facet 324 has an angle θ₂ 335 relative to the surface 301 of lightguide 205. In response to receiving display light 218 from the electrochromic facet 322, the reflective facet 324 is configured to reflect display light 218 based on the angle θ₂ 335 of the reflective facet 324. For example, the reflective facet 324 is configured to reflect display light 218 such that display light 218 propagates through lightguide 205 along a second path 315. In some embodiments, the second path 315 is associated with a second portion of an FOV area 106 to be illuminated. That is to say, display light 218 propagating through lightguide 205 along the second path 315 is configured to illuminate a second portion of FOV area 106 that is different from the first portion of FOV area 106. In this way, the electrochromic reflector 328 is configured to expand the FOV area 106 by providing additional paths for display light 218 to propagate through lightguide 205. Further, because the electrochromic reflector 328 is disposed within lightguide 205, the electrochromic reflector 328 increases the FOV area 106 without increasing the size of an HMD including projection system 300.

In embodiments, mirror control circuitry 326 is configured to change the states of one or more electrochromic facets 322 of electrochromic reflector 328 based on the gaze of a user. For example, according to some embodiments, projection system 300 further includes gaze tracking circuitry 330. Gaze tracking circuitry 330, for example, includes circuitry, sensors (e.g., infrared sensors, laser sensors), cameras, or any combination thereof configured to determine the direction of the gaze of an eye 220 of the user. Based on a determined direction of the gaze of an eye 220 of the user, gaze tracking circuitry 330 is configured to determine which portion of the FOV area 106 an eye 220 of the user is looking at. As an example, based on a determined first direction of the gaze of an eye 220 of the user, gaze tracking circuitry 330 is configured to determine that the eye 220 of the user is looking at a first portion of the FOV area 106. As another example, based on a determined second direction of the gaze of an eye 220 of the user, gaze tracking circuitry 330 is configured to determine that the eye 220 of the user is looking at a second portion of the FOV area 106 that is different from the first portion of the FOV area 106. According to some embodiments, based on the portion of the FOV area 106 that the eye 220 of the user is determined to be looking at, mirror control circuitry 326 is configured to generate one or more control signals 325.

As an example, in response to gaze tracking circuitry 330 determining that the eye 220 of the user is looking at a first portion of the FOV area 106, mirror control circuitry 326 is configured to generate a control signal 325 that, when received by an electrochromic facet 322 of electrochromic reflector 328, causes electrochromic reflector 328 to direct display light 218 along a path (e.g., first path 305, second path 315) corresponding to the first portion of the FOV area 106. For example, based on the eye 220 of the user looking at a first portion of the FOV area 106, mirror control circuitry 326 is configured to generate a control signal 325 representing a first current and provides the control signal 325 to the electrochromic facet 322. In response to receiving the control signal 325, the electrochromic facet 322 is configured to enter a first state (e.g., reflective state) and is configured to reflect display light 218 such that it propagates through lightguide 205 along a first path 305 corresponding to the first portion of the FOV area 106. As another example, based on the eye 220 of the user looking at a second portion of the FOV area 106 that is different from the first portion, mirror control circuitry 326 is configured to generate a control signal 325 representing a second current and provides the control signal 325 to the electrochromic facet 322. In response to receiving the control signal 325, the electrochromic facet 322 is configured to enter a second state (e.g., transmittance state) and is configured to transmit display light 218 to the reflective facet 324. In response to receiving display light 218, the reflective facet 324 reflects display light 218 such that it propagates through lightguide 205 along a second path 315 corresponding to the second portion of the FOV area 106. In this way, electrochromic reflector 328 is configured to only illuminate the portions of the FOV area 106 that a user is currently looking at rather than illuminating the entirety of the FOV area 106, reducing the power demands of the projection system.

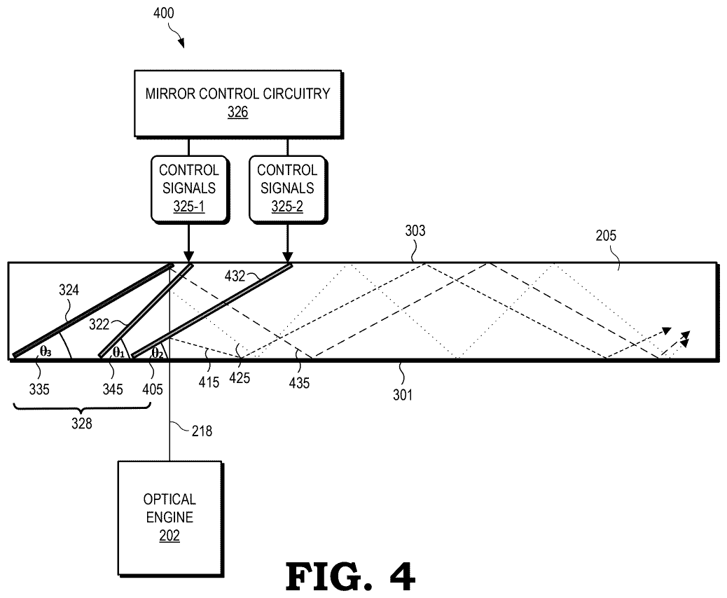

Referring now to FIG. 4, a projection system 400 including an electrochromic reflector with two or more electrochromic facets is presented. According to embodiments, projection system 400 is similar to or the same as projection systems 200, 300, and, in some embodiments, is implemented in an HWD or other display system, such as the display system 100 of FIG. 1. Within projection system 400, the electrochromic reflector 328 includes a first electrochromic facet 322 disposed within lightguide 205 at a first angle θ₁ 345 relative to a surface 301 of lightguide 205 and a second electrochromic facet 432 (e.g., similar or the same as first electrochromic facet 322) disposed within lightguide 205 at a second angle θ₂ 405 relative to the surface 201 of lightguide 205. Further, the electrochromic reflector 328 includes reflective facet 324 disposed within lightguide 205 at a third angle θ₃ 335 relative to a surface 301, 303 of lightguide 205. To control the state of the first electrochromic facet 322, mirror control circuitry 326 is configured to provide a first set of control signals 325-1 each representative of a corresponding voltage, current, or both. Likewise, to control the state of the second electrochromic facet 432, mirror control circuitry 326 is configured to provide a second set of control signals 325-2 each representative of a corresponding voltage, current, or both.

In embodiments, optical engine 202 is configured to emit display light 218 toward the first surface 301 of lightguide 205. After display light 218 passes through the first surface 301 of lightguide 205, display light 218 is received by the second electrochromic facet 405 of electrochromic reflector 328. In response to the second electrochromic facet 405 being in a first state (e.g., reflective state), the second electrochromic facet 405 is configured to reflect display light 218 based on the angle θ₂ 405 of the second electrochromic facet 405. For example, the second electrochromic facet 405 is configured to reflect display light 218 such that display light 218 propagates through lightguide 205 along a first path 415 corresponding to a first portion of the FOV area 106. That is to say, display light 218 propagating through lightguide 205 along the first path 415 is configured to illuminate a first portion of the FOV area 106. In response to the second electrochromic facet 405 being in a second state (e.g., transmittance state), the second electrochromic facet 405 is configured to transmit display light 218 to the first electrochromic facet 322. If the first electrochromic facet 322 is in a first state (e.g., reflective state), the first electrochromic facet 322 is configured to reflect display light 218 based on the angle θ₁ 345 of the first electrochromic facet 322. As an example, the first electrochromic facet 322 is configured to reflect display light 218 such that display light 218 propagates through lightguide 205 along a second path 425 corresponding to a second portion of the FOV area 106. In embodiment, display light 218 propagating through lightguide 205 along the second path 425 is configured to illuminate the second portion of the FOV area 106.

If the first electrochromic facet 322 is in a second state (e.g., transmittance state), the first electrochromic facet 322 is configured to transmit display light 218 to the reflective facet 324. In response to receiving the display light 218, the reflective facet 324 is configured to reflect the display light 218 based on the angle θ₃ 335 of the reflective facet 324. For example, the reflective facet 324 is configured to reflect display light 218 such that display light 218 propagates through lightguide 205 along a third path 435 corresponding to a third portion of the FOV area 106. According to embodiments, display light 218 propagating through lightguide 205 along the third path 435 is configured to illuminate the third portion of the FOV area 106. In this way, electrochromic reflector 328 is configured to illuminate certain portions of the FOV area 106 based on the respective states of the electrochromic facets 322 of the electrochromic reflector 328.

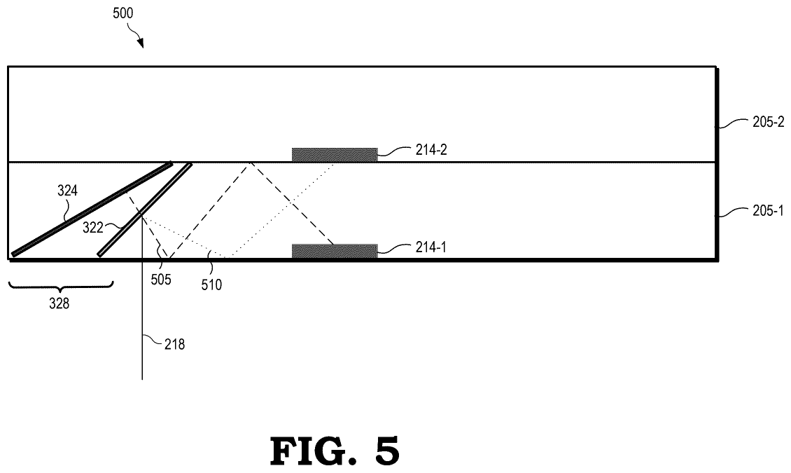

Referring now to FIG. 5 a stacked lightguide 500 including an electrochromic reflector is presented. In embodiments, stacked lightguide 500 is implemented in projection systems 200, 300, 400, and, in some embodiments, is implemented in an HWD or other display system, such as the display system 100 of FIG. 1. According to embodiments, stacked lightguide 500 is formed from a first lightguide 205-1 and a second lightguide 205-2. The first lightguide 205-1, for example, includes a first incoupler 214-1 that corresponds to a first portion of the FOV area 106. That is to say, the first incoupler 214-1 is configured to direct light such that a first portion of the FOV area 106 is illuminated. Further, the second lightguide 205-2 includes a second incoupler 214-2 that corresponds to a second portion of the FOV area 106 that is different from the first portion of the FOV area 106. As an example, the second incoupler 214-2 is configured to direct light such that the second portion of the FOV area 106 is illuminated.

In some embodiments, the first lightguide 205-1 includes the electrochromic reflector 328 disposed with the first lightguide 205-1. The electrochromic reflector 328 includes, for example, the electrochromic facet 322 and the reflective facet 324. According to embodiments, the electrochromic reflector 328 is configured to receive display light 218 from, for example, optical engine 202. To this end, within the electrochromic reflector 328, display light 218 is first received by the electrochromic facet 322. In response to the electrochromic facet 322 being in a first state (e.g., reflective state), electrochromic facet 322 is configured to reflect display light 218 such that display light 218 propagates through the first lightguide 205-1 along a first path 510. In embodiments, display light 218 propagating through the first lightguide 205-1 along the first path 510 is received by the first incoupler 214-1. After receiving the display light 218, the first incoupler 214-1 directs the display light 218 such that a first portion of the FOV area 106 is illuminated. In response to the electrochromic facet 322 being in a second state (e.g., transmittance state), electrochromic facet 322 is configured to transmit display light 218 to the reflective facet 324. The reflective facet 324 then reflects display light 218 such that display light 218 propagates through the first lightguide 205-1 along a second path 505. In embodiments, display light 218 propagating through the first lightguide 205-1 along the second path 505 is received by the second incoupler 214-2 of the second lightguide 205-2. After receiving the display light 218, the second incoupler 214-2 directs the display light 218 such that a second portion of the FOV area 106 is illuminated that is different from the first portion of the FOV area 106.

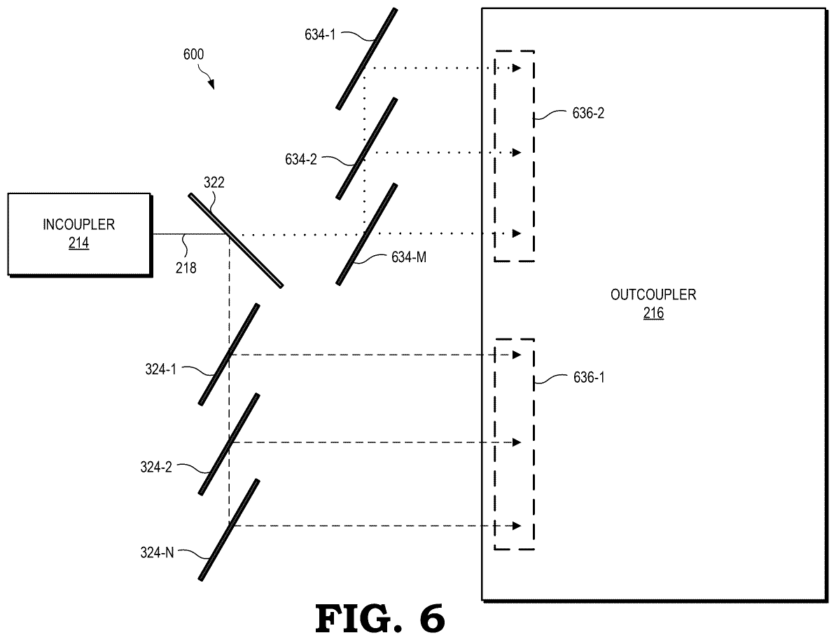

Referring now to FIG. 6, a split EPE 600 including an electrochromic reflector is presented. According to embodiments, split EPE 600 is implemented in projection systems 200, 300, 400, and, in some embodiments, is implemented in an HWD or other display system, such as the display system 100 of FIG. 1. In embodiments, split EPE is configured to expand the exit pupil of display light 218 and includes a first set of reflective facets 324 and a second set of reflective facets 634 (e.g., each similar to or the same as the reflective facet 324). Though the example embodiment of FIG. 6 presents the first set of reflective facets 324 as including three reflective facets (324-1, 324-2, 324-N) representing an N number of reflective facets, in other embodiments, the first set of reflective facets 324 can include any number of reflective facets. Likewise, though the example embodiment of FIG. 6 presents the second set of reflective facets 634 as including three reflective facets (634-1, 634-2, 634-M) representing an M number of reflective facets, in other embodiments, the second set of reflective facets 634 can include any number of reflective facets. In embodiments, each reflective facet of the first set of reflective facets 324 is configured to reflect a respective portion of light (e.g., display light 218) toward a first region 636-1 of outcoupler 216. The first region 636-1 of outcoupler 216, for example, is configured to direct light out of lightguide 205 such that a first portion of FOV area 106 is illuminated. Further, each reflective facet of the second set of reflective facets 634 is configured to reflect a respective portion of light (e.g., display light 218) toward a second region 636-2 of outcoupler 216. The second region 636-2 of outcoupler 216, for example, is configured to direct light out of lightguide 205 such that a second portion of FOV area 106 is illuminated that is different from the first portion of the FOV area 106.

Additionally, in embodiments, split EPE 600 includes an electrochromic reflector (e.g., electrochromic reflector 328) that includes the electrochromic facet 322. According to embodiments, the electrochromic facet 322 is configured to receive display light 218 from incoupler 214. In response to the electrochromic facet 322 being in a first state (e.g., reflective state), the electrochromic facet 322 reflects display light 218 toward the first set of reflective facets 324. Each reflective facet of the first set of reflective facets 324 then reflects a respective portion of display light 218 toward the first region 636-1 of the outcoupler 216. The outcoupler 216 then directs display light 218 out of lightguide 205 such that a first portion of the FOV area 106 is illuminated. In response to the electrochromic facet 322 being in a second state (e.g., transmittance state), the electrochromic facet 322 transmits display light 218 to the second set of reflective facets 634. Each reflective facet of the second set of reflective facets 634 then reflects a respective portion of display light 218 toward the second region 636-2 of the outcoupler 216. The outcoupler 216 then directs display light 218 out of lightguide 205 such that a second portion of the FOV area 106 is illuminated which is different from the first region of the FOV area 106.

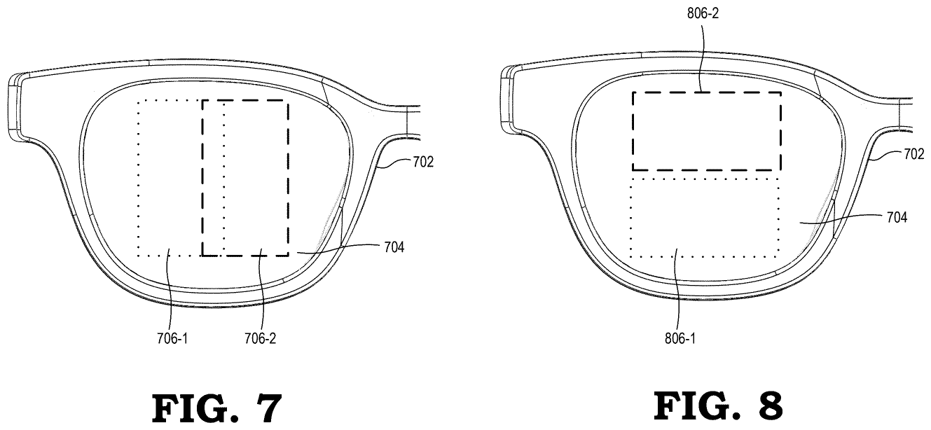

Referring now to FIG. 7, example overlapping portions 706 of an FOV area provided by an electrochromic reflector are presented. For example, an FOV area (e.g., FOV area 106) within an optical combiner 704 of an HWD 702 (e.g., similar to or the same as display system 100) is formed from a first portion 706-1 and a second portion 706-2. In embodiments, the first portion 706-1 and the second portion 706-2 are adjacent in a first (e.g., vertical) direction relative to the optical combiner 704 with at least a region of the first portion 706-1 overlapping with at least a region of the second portion 706-2. According to embodiments, an electrochromic reflector (e.g., electrochromic reflector 328) is configured to direct display light 218 such that the first portion 706-1 or the second portion 706-2 is illuminated based on the state of one or more electrochromic facets (e.g., electrochromic facets 322, 432). As an example, based on an electrochromic facet being in a first state (e.g., reflective state), the electrochromic reflector is configured to direct display light 218 such that the first portion 706-1 is illuminated. Further, based on an electrochromic facet being in a second state (e.g., transmittance state), the electrochromic reflector is configured to direct display light 218 such that the second portion 706-2 is illuminated. Referring now to FIG. 8, example separated portions 806 of an FOV area are presented. In embodiments, an FOV area (e.g., FOV area 106) within an optical combiner 704 of HWD 702 is formed from a first portion 806-1 and a second portion 806-2. In embodiments, the first portion 806-1 and the second portion 806-2 are adjacent in a second (e.g., horizontal) direction relative to the optical combiner 704 with the entirety of the first portion 806-1 separate from the entirety of the second portion 806-2 such that the first portion 806-1 and the second portion 806-2 do not overlap. In some embodiments, an electrochromic reflector (e.g., electrochromic reflector 328) is configured to direct display light 218 such that the first portion 806-1 or the second portion 806-2 is illuminated based on the state of one or more electrochromic facets (e.g., electrochromic facets 322, 432). As an example, based on an electrochromic facet being in a first state (e.g., reflective state), the electrochromic reflector is configured to direct display light 218 such that the first portion 806-1 is illuminated. Further, based on an electrochromic facet being in a second state (e.g., transmittance state), the electrochromic reflector is configured to direct display light 218 such that the second portion 806-2 is illuminated.

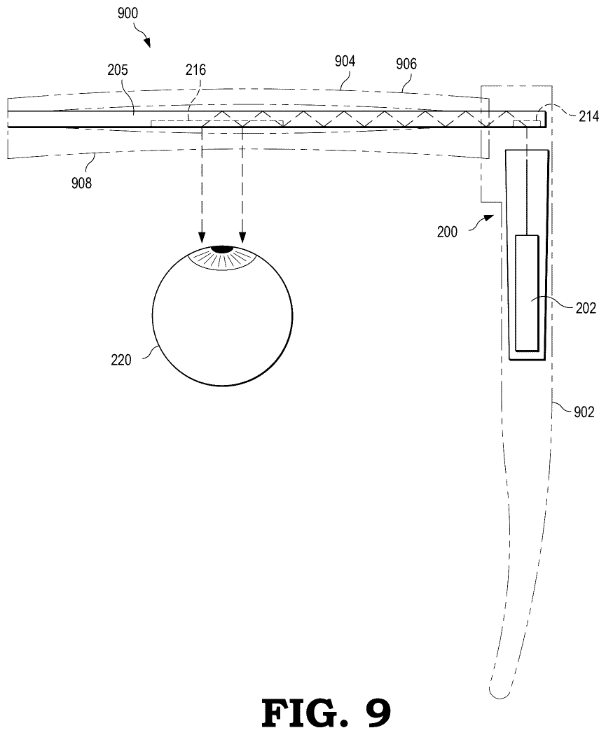

FIG. 9 illustrates a portion of an eyewear display 900 that includes the projection system 200 of FIG. 2, the projection system 300 of FIG. 3, the projection system 400 of FIG. 4, or any combination thereof. In some embodiments, the eyewear display 900 represents the display system 100 of FIG. 1. The optical engine 202, the incoupler 214, the outcoupler 216, and a portion of the lightguide 205 are included in an arm 902 of the eyewear display 900, in the present example.

The eyewear display 900 includes an optical combiner lens 904, which includes a first lens 906, a second lens 908, and the lightguide 205, with the lightguide 205 disposed between the first lens 906 and the second lens 908. Light exiting through the outcoupler 216 travels through the second lens 908 (which corresponds to, for example, the lens element 110 of the display system 100). In use, the light exiting second lens 908 enters the pupil of an eye 220 of a user wearing the eyewear display 900, causing the user to perceive a displayed image carried by the display light output by the optical engine 202. The optical combiner lens 904 is substantially transparent, such that light from real-world scenes corresponding to the environment around the eyewear display 900 passes through the first lens 906, the second lens 908, and the lightguide 205 to the eye 220 of the user. In this way, images or other graphical content output by the projection systems 200, 300, 400 are combined (e.g., overlayed) with real-world images of the user's environment when projected onto the eye 220 of the user to provide an AR experience to the user.

Although not shown in the depicted example, in some embodiments additional optical elements are included in any of the optical paths between the optical engine 202 and the incoupler 214, in between the incoupler 214 and the outcoupler 216, and/or in between the outcoupler 216 and the eye 220 of the user (e.g., in order to shape the display light for viewing by the eye 220 of the user). As an example, electrochromic reflector 328 is used to direct display light 218 within lightguide 205 such that certain portions of an FOV area 106 are illuminated. Also, in some embodiments, an exit pupil expander, such as a fold grating, is arranged in an intermediate stage between incoupler 214 and outcoupler 216 to receive light that is coupled into lightguide 205 by the incoupler 214, expand the light, and redirect the light towards the outcoupler 216, where the outcoupler 216 then couples the display light out of lightguide 205 (e.g., toward the eye 220 of the user).

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A head-worn display (HWD), comprising:
an optical engine configured to emit a display light;
a lightguide; and
an electrochromic facet configured to direct the display light such that the display light propagates through the lightguide along a path of a plurality of paths based on a state of the electrochromic facet.

2.-9. (canceled)

10. The HWD of claim 1, further comprising:
a mirror control circuitry configured to control the state of the electrochromic facet based on a gaze of a user.

11. The HWD of claim 1, wherein the electrochromic facet is disposed within the lightguide.

12. A lightguide for a head-worn display (HWD), comprising:
one or more electrochromic facets configured to direct a display light such that the display light propagates through the lightguide along a path of a plurality of paths based on one or more respective states of the one or more electrochromic facets.

13. The lightguide of claim 12, wherein each path of the plurality of paths corresponds to a respective portion of a field of view (FOV) area of the HWD.

14. The lightguide of claim 13, wherein a first facet of the one or more electrochromic facets is configured to direct the display light such that the display light propagates through the lightguide along a first path of the plurality of paths based on a first electrochromic facet being in a first state.

15. The lightguide of claim 14, wherein the first state includes a reflective state and the first electrochromic facet is configured to reflect the display light such that the display light propagates through the lightguide along the first path.

16. The lightguide of 14, wherein the first electrochromic facet is configured to transmit the display light to a second electrochromic facet of the one or more electrochromic facets based on the first electrochromic facet being in a second state.

17. The lightguide of claim 16, wherein the second electrochromic facet is configured to direct the display light such that the display light propagates through the lightguide along a second path of the plurality of paths based on the second electrochromic facet being in the first state.

18. The lightguide of 16, wherein the second electrochromic facet is configured to direct the display light such that the display light propagates through the lightguide along a third path of the plurality of paths based on the second electrochromic facet being in the second state.

19. The lightguide of claim 12, wherein the one or more respective states of the one or more electrochromic facets are determined by a mirror control circuitry configured to control the one or more respective states of the one or more electrochromic facets based on a gaze of a user.

20. The lightguide of claim 12, wherein the one or more electrochromic facets are disposed within the lightguide.

21. A method, comprising:
emitting a display light toward a lightguide; and
directing, by an electrochromic facet disposed within the lightguide, the display light such that the display light propagates through the lightguide along a path of a plurality of paths based on a state of the electrochromic facet.

22. The method of claim 21, wherein each path of the plurality of paths corresponds to a respective portion of a field of view (FOV) area.

23. The method of claim 22, further comprising:
directing, by the electrochromic facet, the display light such that the display light propagates through the lightguide along a first path of the plurality of paths based on the electrochromic facet being in a first state.

24. The method of claim 23, wherein the display light propagating through the lightguide along the first path of the plurality of paths is configured to illuminate a first portion of the FOV area.

25. The method of 23, further comprising:
directing, by the electrochromic facet, the display light such that the display light propagates through the lightguide along a second path of the plurality of paths based on the electrochromic facet being in a second state.

26. The method of claim 25, wherein the display light propagating through the lightguide along the second path of the plurality of paths is configured to illuminate a second portion of the FOV area.

27. The method of 21, further comprising:
controlling the state of the electrochromic facet based on a gaze of a user.
